(19) United States
(12) Patent Application Publication
(10) Pub. No.: US 2016/0089799 A1
(43) Pub. Date: Mar. 31, 2016

(54) ROTARY ELECTRIC SHAVER

(71) Applicant: IZUMI PRODUCTS COMPANY, Matsumoto-shi (JP)

(72) Inventor: Yoshiyuki MIMURA, Matsumoto-shi (JP)

(73) Assignee: IZUMI PRODUCTS COMPANY, Matsumoto-shi (JP)

(21) Appl. No.: 14/828,746

(22) Filed: Aug. 18, 2015

(30) Foreign Application Priority Data
Sep. 30, 2014 (JP) 2014-199918

(51) Int. Cl. B26B 19/14

(52) U.S. Cl. CPC B26B 19/143

(57) ABSTRACT

A rotary electric shaver includes an outer blade whose upper surface functions as annular shaving surfaces and having multiple hair inlets formed therein, and an inner blade that has a small blade which rotates while coming into sliding contact with a lower surface of the outer blade from below the annular shaving surfaces and. At least a portion of the multiple hair inlets is formed in an elongated hole shape extending along a radial direction of the annular shaving surfaces and, and an end portion (alternatively, both end portions and) in the radial direction has a widened portion (alternatively, and) which is open wider in a circumferential direction than a central portion.

### CROSS-REFERENCE TO RELATED APPLICATION

This application is based upon and claims the benefit of priority of the prior Japanese Patent Application No. P2014-199918, filed on Sep. 30, 2014, and the entire contents of which are incorporated herein by reference.

### FIELD

The present invention relates to a rotary electric shaver.

### BACKGROUND

For example, a rotary electric shaver is known which cuts hair entering multiple hair inlets while including an outer blade whose upper surface functions as an annular shaving surface having the multiple hair inlets formed therein and an inner blade that has a small blade which rotates while coming into sliding contact with a lower surface of the outer blade from below the annular shaving surface (refer to PTL 1).

### CITATION LIST

### Patent Literature

PTL 1: JP-T-2006-510430

### SUMMARY OF INVENTION

### Technical Problem

In the related art, a rotary electric shaver particularly has the following important issues: (a) whether an outer blade can smoothly move while following delicate and uneven portions of skin; (b) whether hair can be reliably caught corresponding to different hair characteristics of each user and can be prevented from remaining unshaved; (c) whether skin can be prevented from being damaged due to deep shaving when an outer blade is strongly pressed against skin.

For example, according to a configuration of disposing a ridge in a partial area on an outer blade shaving surface in the circumferential direction as in the rotary electric shaver disclosed in PTL 1, it is possible to protect skin by reducing contact pressure applied to skin. On the other hand, there may be a problem of poor shaving performance in such a case. As described above, it is relatively easy to respectively and independently solve the above-described issues (a) to (c). However, when all of the issues are intended to be solved at the same time, various factors included therein conflict with each other. Consequently, a further advanced technique is required.

The present invention is made in view of the above-described circumstances, and an object thereof is to provide a rotary electric shaver whose outer blade can smoothly move along skin, which can improve hair catching performance, and which can prevent the skin from being damaged due to deep shaving.

### Solution to Problem

The object may be realized by providing embodiments disclosed hereinafter.

A disclosed rotary electric shaver includes an outer blade whose upper surface functions as annular shaving surfaces having multiple hair inlets formed therein, and an inner blade that has a small blade which rotates while coming into sliding contact with a lower surface of the outer blade from below the annular shaving surfaces, in which at least a portion of the multiple hair inlets is formed in an elongated hole shape extending along a radial direction of the annular shaving surfaces, and both end portions or one end portion in the radial direction has a widened portion which is open wider in a circumferential direction than a central portion.

### Advantageous Effects

According to the rotary electric shaver disclosed herein, an outer blade can smoothly move along skin, it is possible to improve hair catching performance, and it is possible to prevent the skin from being damaged due to deep shaving.

### BRIEF DESCRIPTION OF THE DRAWINGS

FIG. 1 is a schematic view (perspective view) illustrating an example of a rotary electric shaver according to an embodiment of the present invention.

FIG. 2 is a schematic view (exploded perspective view) illustrating an example of a head unit in the rotary electric shaver illustrated in FIG. 1.

FIG. 3 is a schematic view (perspective view) illustrating an example of an inner blade in the rotary electric shaver illustrated in FIG. 1.

FIG. 4 is a schematic view illustrating a small blade of the inner blade and a portion of an outer blade in the rotary electric shaver illustrated in FIG. 1.

FIG. 5 is a schematic view (plan view) illustrating an example of the outer blade in the rotary electric shaver illustrated in FIG. 1.

FIG. 6 is a partially enlarged view of the outer blade illustrated in FIG. 5.

FIG. 7 is a perspective view of the outer blade illustrated in FIG. 5.

FIG. 8 is a partially enlarged view of the outer blade illustrated in FIG. 7.

FIG. 9 is a sectional view of the outer blade illustrated in FIG. 5.

### DESCRIPTION OF THE EMBODIMENTS

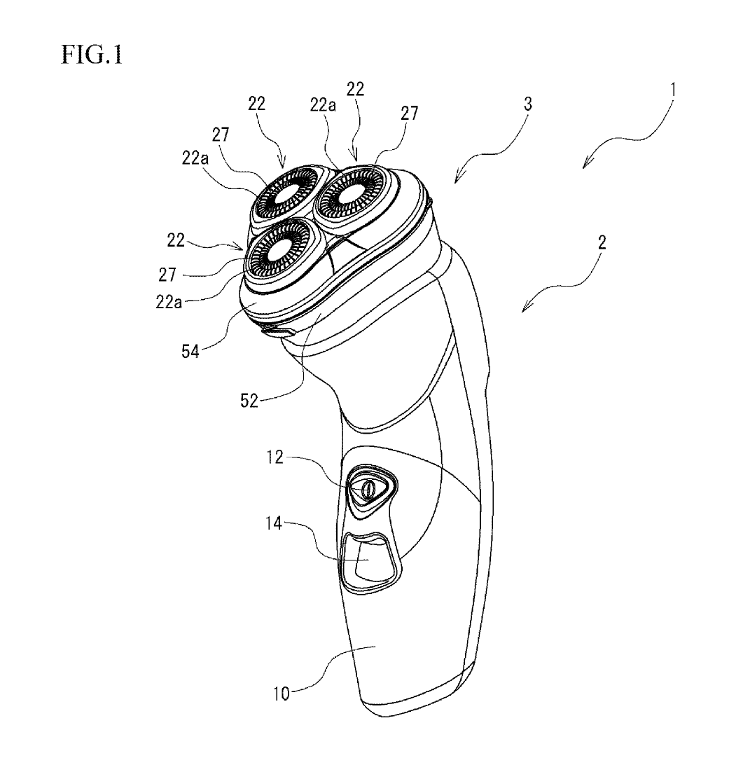

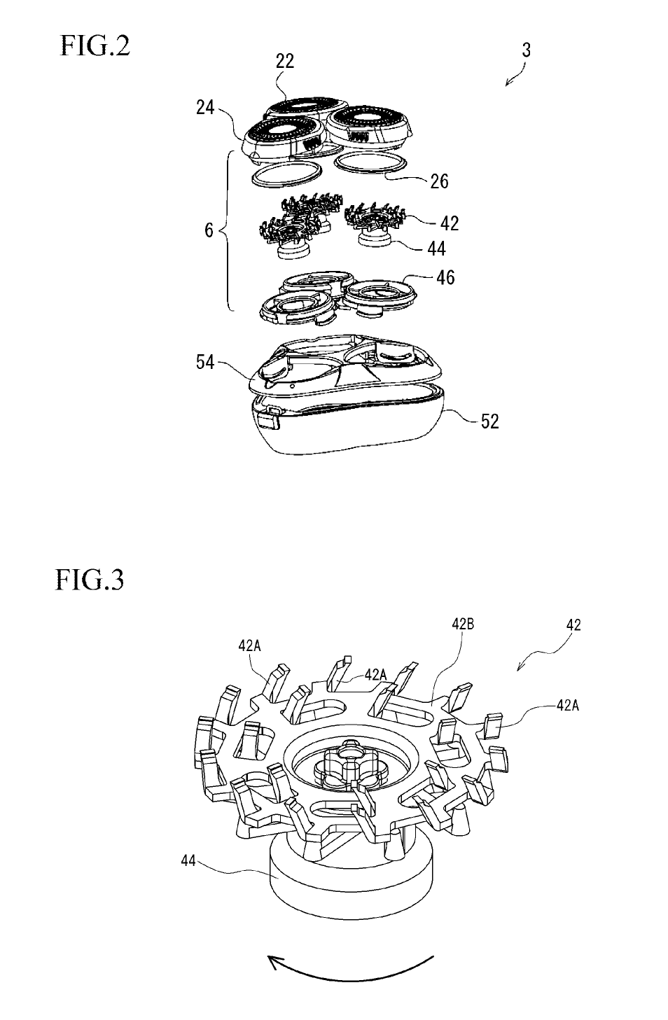

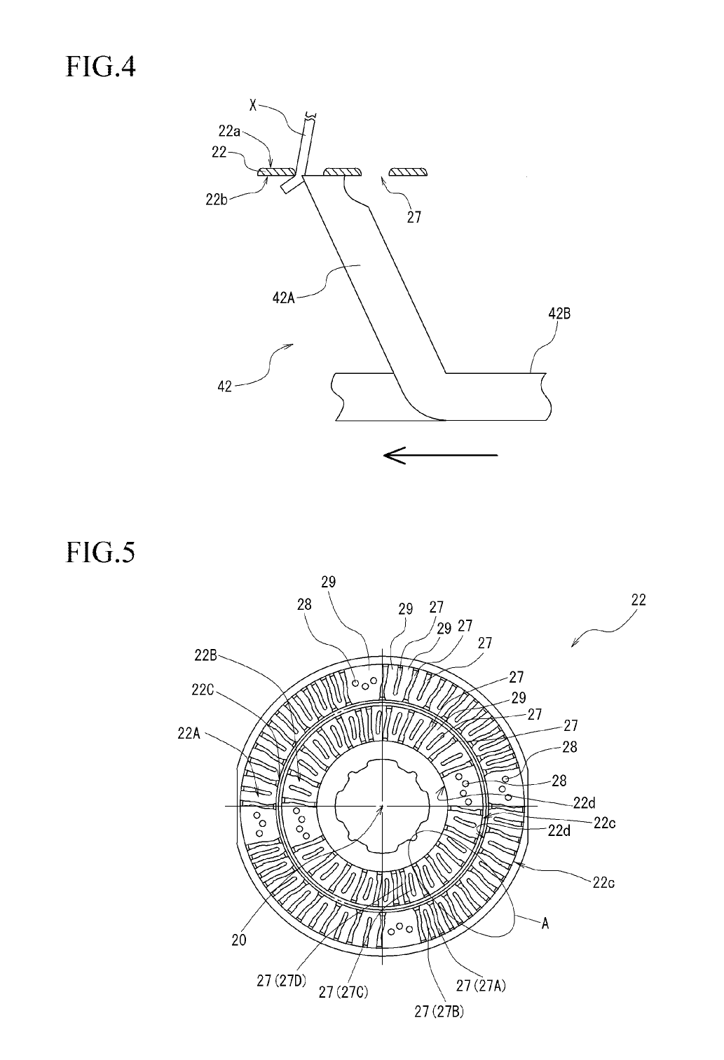

Hereinafter, embodiments of the present invention will be described in detail with reference to the drawings. FIG. 1 is a schematic view (perspective view) illustrating an example of a rotary electric shaver 1 according to the present embodiment. In addition, FIG. 2 is a schematic view (exploded perspective view) illustrating an example of a head unit 3 in the rotary electric shaver 1. In addition, FIG. 3 is a schematic view (perspective view) illustrating an example of an inner blade 42 in the rotary electric shaver 1. FIG. 4 is a schematic view illustrating the inner blade 42 (particularly, small blade 42A) and a portion of an outer blade 22 (cross section). Referring to all drawings used in describing the embodiments, the same reference numerals are given to members having the same function, and repeated description thereof will be omitted in some cases.

As illustrated in FIGS. 1 and 2, the rotary electric shaver 1 according to the present embodiment includes the outer blade 22 having multiple penetrating hair inlets 27 formed therein and the inner blade 42 rotating while coming into sliding contact with a lower surface of the outer blade 22, and cuts hair entering the multiple hair inlets 27 by using the outer blade 22 and the inner blade 42. An example will be described in which the rotary electric shaver 1 has three sets of a blade unit 6 including the outer blade 22 and the inner blade 42. However, without being limited thereto, the present invention may employ one set or other multiple sets. In the present invention, examples of the hair include beards, mustaches, whiskers, and the like.

In FIG. 1, the reference numeral 2 is a main body, and includes a substantially cylindrical case 10. A motor for rotatably driving the inner blade 42, a battery for supplying electric power to the motor, and a control unit for controlling the rotary drive (all not illustrated) are accommodated inside the case 10. A switch button 12 for turning on and off a power source is disposed on a front surface of the case 10. A display unit 14 having an LED lamp for indicating battery residual capacity is disposed below the switch button 12.

As illustrated in FIG. 2, the head unit 3 includes a head case 52 which is held by being connected to an upper portion of the case 10 in the main body 2, a blade frame 54 which covers the head case 52 from above, a drive mechanism (not illustrated) which is accommodated in an inner bottom portion of the head case 52, and three sets of the blade unit 6 which are held in the blade frame 54 so as to be slightly and vertically movable and swingable. Here, each of the blade units 6 includes the outer blade 22 having a substantially disc shape and the inner blade 42 rotating while coming into sliding contact with the lower surface (inner surface) of the outer blade 22. In addition, three sets of blade unit 6 are arranged so as to form a triangle in a plane view. As described above, the present embodiment employs a case example where three sets of the blade unit 6 are included therein. However, a basic configuration may be similarly conceivable even in an alternative case where blade units are included in a combination other than three sets.

Here, the outer blade 22 is configured so that multiple holes 27 serving as hair inlets are formed to penetrate in an axial direction (that is, a direction which is the same as the axial direction of a rotation axis of the inner blade) and the inner blade 42 cuts the hair entering the hair inlets 27. That is, the outer blade 22 is configured so that an upper surface 22a serves as a hair cutting surface which comes into contact with skin of a user and the hair inlets 27 are open on the upper surface 22a. As an example, the upper surface 22a is formed in an annular plane, that is, as an annular shaving surface. In addition, the outer blade 22 has a shape whose peripheral edge is bent downward and an outer blade ring 24 is fitted into the peripheral edge thereof A stopper ring 26 is fitted into an inner periphery of the outer blade ring 24, and the outer blade 22 is fixed to the outer blade ring 24.

On the other hand, the inner blade 42 is fixed to an inner blade holder 44, and a recess for fitting an upper end of an inner blade drive shaft (not illustrated) connected to an output shaft of the motor is formed in a lower portion of the inner blade holder 44. The inner blade 42 is held so as to be swingable to the outer blade 22 side by an inner blade rest 46 fitted into the outer blade ring 24, thereby forming three sets of independent blade units 6.

As illustrated in FIG. 3, the inner blade 42 according to the present embodiment is configured to include multiple small blades 42A in which a metal plate is partially disposed upright from a plate surface 42B (reference numeral is given to only a few of the small blades in order to simplify the illustration). As an example, the inner blade 42 is formed as an integral structure in such a way that a metal plate made of stainless steel is used, and punching and bending are performed thereon by means of pressing work.

The blade unit 6 is assembled so as to include the above-described configuration, thereby bringing the small blade 42A of the inner blade 42 into contact with a lower surface 22b of the outer blade 22 (refer to FIG. 4). In this state, the inner blade 42 is rotatably driven in an arrow direction, thereby enabling a blade edge of the inner blade 42 (small blade 42A) to cut hair X entering the hair inlets 27.

Next, a characteristic configuration of the outer blade 22 according to the present embodiment will be described in detail with reference to the drawings.

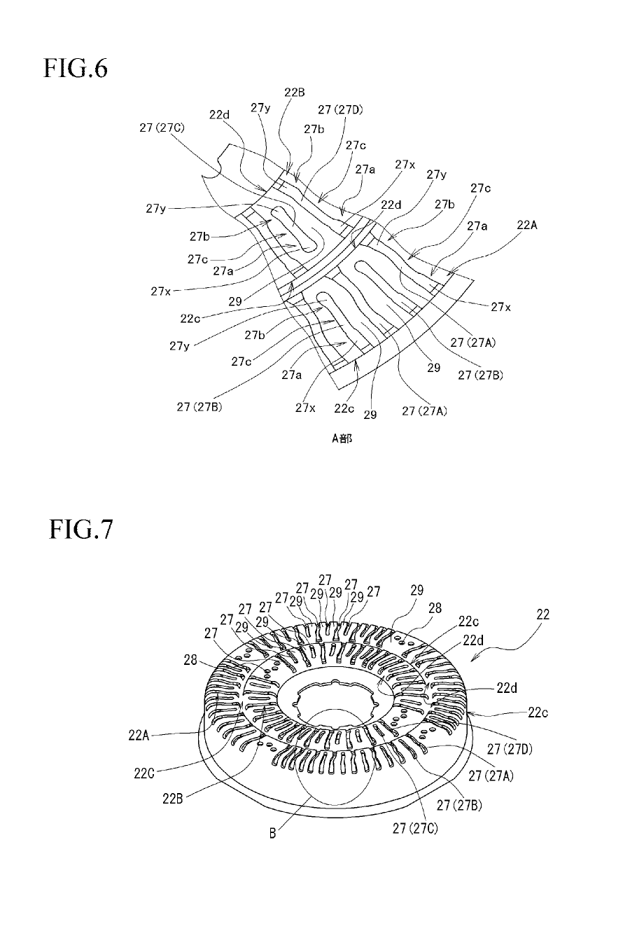

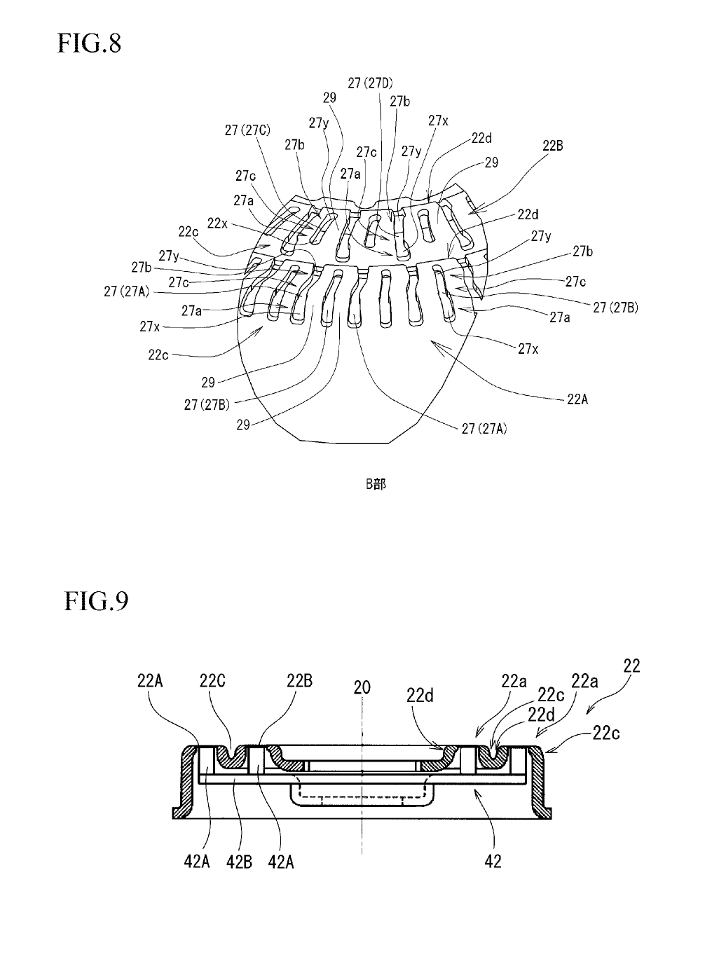

Here, FIG. 5 is a plan view of the outer blade 22, and FIG. 6 is a partially enlarged view (portion A) of FIG. 5. In addition, FIG. 7 is a perspective view of the outer blade 22, and FIG. 8 is a partially enlarged view (portion B) of FIG. 6. In addition, FIG. 9 is a front sectional view of the outer blade 22.

In the present embodiment, as illustrated in FIGS. 5 to 9, two (double) annular shaving surfaces 22A and 22B serving as the upper surface of the outer blade 22 are formed concentrically with a central axis 20, and an annular recessed groove 22C is formed therebetween (intermediate position in the radial direction). As an example, as illustrated in FIG. 9, the annular shaving surfaces 22A and 22B are configured to have the same height along the central axis 20. However, without being limited to this configuration, the annular shaving surface 22B located on the inner side may be configured to be higher along the central axis 20 than the annular shaving surface 22A located on the outer side.

Here, the outer blade 22 is formed as an integral structure in such a way that a metal plate made of stainless steel is used, and punching and bending are performed thereon by means of pressing work. However, without being limited thereto, various configurations can be employed such as a configuration in which the annular shaving surfaces 22A and 22B are separately formed and fixed to each other, or a configuration in which the annular shaving surfaces 22A and 22B are separately formed and connected to each other so as to be mutually movable in the axial direction. Without being limited to two (double) annular shaving surfaces, a configuration may be adopted which includes one (single) annular shaving surface, or alternatively three (triple) or more annular shaving surfaces.

In addition, the annular shaving surfaces 22A and 22B have multiple hair inlets formed thereon. In the present embodiment, the hair inlets include hair inlets 27 having an elongated hole shape in a plan view and hair inlets 28 having a round hole shape in a plan view. Here, the term “round hole shape” is not limited to a perfect circular shape, and is intended to include other circular shapes such as an oval shape or an elliptical shape (in some cases, also corresponding to an “elongated hole shape”). A configuration may be adopted in which the multiple hair inlets include only the hair inlets 27 having the elongated hole shape.

Here, with regard to the elongated hole-shaped hair inlet 27, if the entire opening portion of the hair inlet is formed to be larger, hair is likely to enter the hair inlet, as a matter of course. Accordingly, it is possible to improve performance for catching various types of hair such as long hair, coarse hair, or the like. However, in that case, an area of a “blank portion” (also called a “solid portion”) 29 which is a planar area having no hair inlet decreases. Thus, smooth movement along skin is no longer possible, and a user's skin comes to feel an unfavorable sensation. Consequently, there is a conflicting problem in that the skin is likely to be damaged due to deep shaving even if a pressing force applied to the skin decreases.

This problem can be solved as follows. The outer blade 22 according to the present embodiment includes the hair inlets 27 (illustrated as 27A to 27D in the drawing). The hair inlets 27 have an elongated hole shape extending along the radial direction of the annular shaving surfaces 22A and 22B, and have widened portions (illustrated as 27x and 27y in the drawing) which are open so as to be wider in the circumferential direction than a central portion 27c, in only both end portions 27a and 27b in the radial direction or in only one end portion 27a (alternatively 27b). Hereinafter, the embodiment will be described as an example.

### First Embodiment

First, hair inlets 27A according to a first embodiment of the above-described hair inlets 27 are open in an elongated hole shape extending along the radial direction from an upper surface 22a of the outermost annular shaving surface 22A across both side surfaces of an outer surface 22c and an inner surface 22d. The hair inlets 27A respectively have the widened portions 27x and 27y in both end portions 27a and 27b of the hair inlets 27A (refer to FIGS. 5 to 8). Both of the widened portions 27x and 27y are configured to be individually formed in each of the hair inlets 27A (that is, are not configured so that the widened portions are combined with each other across the adjacent hair inlet 27A and function as a single common opening portion).

More specifically, the hair inlet 27A formed on the outermost annular shaving surface 22A includes the widened portion 27x which is formed from the upper surface 22a of the annular shaving surface 22A across the outer surface 22c. Furthermore, the hair inlet 27A includes the widened portion 27y which is formed from the upper surface 22a of the annular shaving surface 22A across the inner surface 22d (as a modification example, a configuration may be adopted which does not have the widened portion 27y disposed therein).

According to the above-described configuration, hair is likely to be introduced into a hole (hair inlet) by providing the widened portions 27x and 27y formed in the hair inlet 27A, particularly by providing the widened portion 27x formed from the upper surface 22a across the outer surface 22c. Accordingly, it is possible to improve performance for catching various types of hair such as long hair, coarse hair, or the like. At the same time, it is possible to ensure a wider area of the blank portion 29 on the upper surface 22a, as compared to a case where the entire opening portion is formed to be larger. Therefore, it is possible to solve the problem of a user's unfavorable sensation or the problem of damaged skin caused by deep shaving.

In this case, the widened portion 27x is formed so that the circumferential width gradually becomes wider as a planar shape thereof on the upper surface 22a of the outer blade 22 goes from the radially central portion 27c in the direction toward the end portion 27a. In addition, the widened portion 27y may have the same shape formed toward the end portion 27b, or may have a different shape.

According to this configuration, the opening width becomes wider in an edge portion (boundary portion between the upper surface 22a and the outer surface 22c) on the annular shaving surface 22A. Accordingly, it is possible to further improve hair catching performance. In addition, it is also possible to achieve an advantageous effect of preventing a user from feeling an unfavorable sensation by changing the opening width gradually.

As a modification example, the widened portion 27x may be formed on only the outer surface 22c without being formed from the upper surface 22a of the outer blade 22 across the outer surface 22c. In addition, the widened portion 27y may also have the same shape on the inner surface 22d, or may have a different shape.

According to this modification example, improved hair catching performance is provided. In particular, it is possible to achieve much more advantageous effects in view of preventing a user's unfavorable sensation and preventing deep shaving.

In the present embodiment, the shape of the elongated hole-shaped hair inlet 27 is not particularly limited. For example, it is possible to employ various shapes such as, for example, a shape whose long side portion is linear or a shape whose long side portion is entirely or partially curved.

As an example, the hair inlet 27 having an elongated hole shape according to the present embodiment is formed so that the long side portion is partially (here, intermediate portion in the longitudinal direction) curved as illustrated in FIGS. 5 to 8. As described above, according to a configuration in which the long side portion has a partially (or entirely) curved portion, long hair or coarse hair is particularly likely to be caught on the curved portion, and is likely to be introduced into holes (into the hair inlets). Accordingly, it is possible to achieve further improved hair catching performance In the present embodiment, the outer blade 22 is formed by means of shearing press work. In this manner, it is possible to form the hair inlet having a complicated shape as described above. However, another method for forming the hair inlet may employ etching, ECM, or the like.

As illustrated in FIGS. 5 to 8, a configuration may be adopted in which the annular shaving surface (22A as an example) has the hair inlet 27A and a hair inlet 27B (alternatively, hair inlet 27C, to be described later) which are combined with each other (for example, alternately juxtaposed). According to this configuration, it is possible to compatibly improve the hair catching performance and a user's favorable sensation.

In addition, a configuration may be adopted in which the hair inlets 28 having a round hole shape are appropriately juxtaposed. According to this configuration, it is possible to increase an area of the blank portion without significantly deteriorating the hair catching performance by using the hair inlet 27 having an elongated hole shape. Accordingly, it is possible to provide further improved skin-fitting shaving and a favorable sensation to the skin, and thus it is possible to prevent deep shaving.

### Second Embodiment

Next, the hair inlet 27B according to a second embodiment of the above-described hair inlet 27 is open in an elongated hole shape extending along the radial direction from the upper surface 22a of the outermost annular shaving surface 22A across the outer surface 22c, and has the widened portion 27x in one end portion 27a of the hair inlet 27B (refer to FIGS. 5 to 8).

The basic configuration and operation effect of the present embodiment are the same as those in the above-described first embodiment, and thus points which are different therefrom will be mainly described.

The present embodiment adopts a configuration in which the hair inlet 27A formed on the outermost annular shaving surface 22A includes the widened portion 27x which is formed from the upper surface 22a of the outermost annular shaving surface 22A across the outer surface 22c.

In contrast, a configuration is adopted in which the other end portion 27b of the hair inlet 27B does not reach the inner surface 22d and is formed on the upper surface 22a. The other end portion 27b may adopt a configuration which has the same widened portion as the widened portion 27y of the hair inlet 27C according to a third embodiment (to be described later), or may adopt a configuration without having the widened portion.

According to the configuration described in the present embodiment, it is possible to ensure a wider area of the blank portion 29 on the upper surface 22a, compared to the configuration according to the first embodiment. Accordingly, in particular, it is possible to achieve much more advantageous effects in view of preventing a user's unfavorable sensation and preventing deep shaving.

Although not illustrated, the inner peripheral annular shaving surface 22B may also have the same hair inlet as the hair inlet 27B according to the present embodiment.

### Third Embodiment

Next, the hair inlets 27C according to a third embodiment of the above-described hair inlet 27 respectively have the widened portions 27x and 27y in both end portions 27a and 27b of the hair inlets 27C (refer to FIGS. 5 to 8).

The basic configuration and operation effect of the present embodiment are the same as those in the above-described first embodiment, and thus points which are different therefrom will be mainly described.

In the present embodiment, the hair inlet 27C disposed on the inner peripheral annular shaving surface 22B is not formed from the upper surface 22a of the outer blade 22 across the outer surface 22c, and is formed on only the upper surface 22a. Accordingly, the widened portion 27x is not formed from the upper surface 22a of the outer blade 22 across the outer surface 22c, and is formed on only the upper surface 22a. In addition, the widened portion 27y is not formed from the upper surface 22a of the outer blade 22 across the inner surface 22d, and is formed on only the upper surface 22a (as a modification example, a configuration may be adopted which has only one of the widened portions 27x and 27y).

According to this configuration, it is possible to ensure further wider area of the blank portion 29 on the upper surface 22a, as compared to the configuration according to the second embodiment. Accordingly, it is possible to achieve further more advantageous effects in view of preventing a user's unfavorable sensation and preventing deep shaving.

Although not illustrated, the outer peripheral annular shaving surface 22A may also have the same hair inlet as the hair inlet 27C according to the present embodiment.

### Fourth Embodiment

Next, hair inlets 27D according to a fourth embodiment of the above-described hair inlet 27 respectively have the widened portions 27x and 27y in both end portions 27a and 27b of the hair inlets 27D (refer to FIGS. 5 to 8).

The basic configuration and operation effect of the present embodiment are the same as those in the above-described first embodiment, and thus points which are different therefrom will be mainly described.

The present embodiment adopts a configuration in which the hair inlet 27D having the same widened portions 27x and 27y as the hair inlet 27A according to the first embodiment is disposed on the inner peripheral annular shaving surface 22B.

According to this configuration, even when the annular shaving surface 22B is the innermost annular shaving surface, hair is likely to be introduced into a hole (hair inlet) by providing the widened portions 27x and 27y, particularly by providing the widened portion 27y formed from the upper surface 22a across the inner surface 22d. Accordingly, it is possible to improve performance for catching various types of hair such as long hair, coarse hair, or the like.

As a modification example, a configuration may be adopted which has only one of the widened portions 27x and 27y.

As described above, according to the rotary electric shaver disclosed in the present invention, the outer blade can smoothly move along skin, it is possible to improve hair catching performance, and it is possible to prevent the skin from being damaged due to deep shaving. In this manner, it is possible to solve the conflicting problems.

Without being limited to the above-described embodiments, the present invention can be modified in various ways within the scope not departing from the spirit of the present invention. In particular, the number of combinations (blade units) between the outer blade and the inner blade and the number of annular shaving surfaces are not limited to the above-described embodiments.

1. A rotary electric shaver comprising:
an outer blade whose upper surface functions as annular shaving surfaces and having multiple hair inlets formed therein; and
an inner blade that has a small blade which rotates while coming into sliding contact with a lower surface of the outer blade from below the annular shaving surfaces and,
wherein at least a portion of the multiple hair inlets is formed in an elongated hole shape extending along a radial direction of the annular shaving surfaces and, and both end portions and or one end portion in the radial direction has a widened portion which is open wider in a circumferential direction than a central portion.

2. The rotary electric shaver according to claim 1,
wherein the widened portion is formed from an upper surface across a side surface of the outer blade.

3. The rotary electric shaver according to claim 2,
wherein the widened portion is formed so that an opening width thereof in the circumferential direction gradually becomes wider as a shape on the upper surface of the outer blade goes from the central portion to the end portion in the radial direction.

4. The rotary electric shaver according to claim 1,
wherein the widened portion is formed on a side surface of the outer blade.

5. The rotary electric shaver according to claim 1,
wherein the widened portion is formed on the upper surface of the outer blade.

6. The rotary electric shaver according to claim 1,
wherein the elongated hole-shaped hair inlet is formed in a shape whose long side portion is linear, or in a shape whose long side portion is entirely or partially curved.

7. The rotary electric shaver according to claim 2,
wherein the elongated hole-shaped hair inlet is formed in a shape whose long side portion is linear, or in a shape whose long side portion is entirely or partially curved.

8. The rotary electric shaver according to claim 3,
wherein the elongated hole-shaped hair inlet is formed in a shape whose long side portion is linear, or in a shape whose long side portion is entirely or partially curved.

9. The rotary electric shaver according to claim 4,
wherein the elongated hole-shaped hair inlet is formed in a shape whose long side portion is linear, or in a shape whose long side portion is entirely or partially curved.

10. The rotary electric shaver according to claim 5,
wherein the elongated hole-shaped hair inlet is formed in a shape whose long side portion is linear, or in a shape whose long side portion is entirely or partially curved.
